(19) United States
(12) Patent Application Publication
(10) Pub. No.: US 2025/0368009 A1
(43) Pub. Date: Dec. 4, 2025

(54) VEHICLE AIR CONDITIONER

(71) Applicant: Hanon Systems, Daejeon (KR)

(72) Inventors: Yong Sik KIM, Daejeon (KR); Jun Chul AN, Daejeon (KR); Sang Ki LEE, Daejeon (KR); Seung Min LEE, Daejeon (KR); Seung Ho LEE, Daejeon (KR)

(73) Assignee: Hanon Systems, Daejeon (KR)

(21) Appl. No.: 19/225,721

(22) Filed: Jun. 2, 2025

(30) Foreign Application Priority Data
Jun. 4, 2024 (KR) 10-2024-0073251

(51) Int. Cl. B60H 1/32; B60H 1/00

(52) U.S. Cl. CPC B60H 1/3233; B60H 1/00328

(57) ABSTRACT

A vehicle air conditioner according to the present invention includes an air conditioner case, and a cooling heat exchanger installed on an internal flow path of the air conditioner case. The air conditioner case includes a hopper-shaped bottom surface configured to receive condensate falling from the cooling heat exchanger and collect the condensate in a portion thereof, a drainage port configured to discharge the condensate collected on the bottom surface of the air conditioner case to the outside, a condensate drainage path configured to guide the condensate falling from the cooling heat exchanger onto the bottom surface of the air conditioner case to the drainage port, and a drainage resistance reduction part configured to reduce a condensate drainage resistance in a region from the condensate drainage path to the drainage port due to an air flow on the internal flow path of the air conditioner case.

### CROSS-REFERENCE TO RELATED PATENT APPLICATION

The present application claims the priority to Korean Patent Application No. 10-2024-0073251, filed on Jun. 4, 2024, the entire contents of which are incorporated herein for all purposes by this reference.

### TECHNICAL FIELD

The present invention relates to a vehicle air conditioner, and more particularly, a vehicle air conditioner in which the structure of the bottom surface of an air conditioner case is improved so that the resistance to drainage of condensate due to reverse air flow from the bottom surface of the air conditioner case to the drainage port can be minimized, and consequently, the condensate on the cooling heat exchanger side falling to the bottom surface of the air conditioner case can be smoothly drained to the drainage port regardless of the reverse air flow.

### BACKGROUND ART

For efficiency in the vehicle interior installation space, it is an important task to make a vehicle air conditioner small and slim.

In particular, in recent years, with the trend toward improved passenger convenience and increased distribution of electric vehicles, there has been a demand for slimmer and smaller devices such as a slim cockpit and a flat floor. In response to this demand, it is a very important task to make the vehicle air conditioner small and slim.

As a method for making the vehicle air conditioner small and slim, there is known a method of improving the internal structure of an air conditioner case to reduce an unnecessary space.

In particular, by changing the positions and postures of various components installed inside an air conditioner case, it is possible to minimize the space required to install a specific component, thereby making the air conditioner small and slim.

For example, as shown in FIGS. 1 and 2, there is known a slim air conditioner technique in which an internal flow path 1a of an air conditioner case 1 is formed to face upward from below in the direction of gravity, and then cooling and heating heat exchangers 3 and 5 are arranged horizontally sequentially from below along the internal flow path 1a.

In particular, the cooling and heating heat exchangers 3 and 5 are sequentially arranged in a substantially horizontally lying posture along the air flow path extending upward from below in the gravity direction of the internal flow path 1a.

The cooling and heating heat exchangers 3 and 5 arranged in this manner cool and heat the air that is introduced into a gravity direction lowest air inlet 7 in the internal flow path 1a and then flows toward uppermost air discharge vents 10.

In this slim air conditioner technique, the internal air flow path of the air conditioner case 1 is formed to extend in the vertical direction, and the cooling and heating heat exchangers 3 and 5 are arranged along the vertical air flow path in a substantially horizontally lying posture, which makes it possible to drastically reduce the height of the air conditioner case.

Accordingly, the vehicle air conditioner can be made slim, thereby increasing the efficiency of the vehicle interior installation space and securing a wider space in the vehicle interior.

However, such a conventional slim vehicle air conditioner has a disadvantage in that the drainage of condensate of the cooling heat exchanger 3 is not smooth because the air flow direction in the internal flow path 1a of the air conditioner case 1 and the condensate drainage direction of the cooling heat exchanger 3 are opposite to each other.

That is, the air flow direction within the air conditioner case 1 is upward from the lowest air inlet 8 of the air conditioner case 1 to the uppermost air discharge vent 10, and the drainage direction of condensate of the cooling heat exchanger 3 is downward from the cooling heat exchanger 3 to the lowermost drainage port 12 of the air conditioner case 1.

Therefore, there is a disadvantage in that the air flow direction in the internal flow path 1a of the air conditioner case 1 and the drainage direction of condensate of the cooling heat exchanger 3 are opposite to each other, and the condensate generated on the surface of the cooling heat exchanger 3 is not smoothly drained toward the drainage port 12 on the bottom surface 1b side of the air conditioner case 1.

In particular, as illustrated in FIG. 2, the bottom surface 1b of the air conditioner case 1 has step portions 14 formed in a stepped manner with respect to the air inlet 8 side in order to maintain a uniform distribution of the airflow introduced to the cooling heat exchanger 3. However, there is a disadvantage in that the condensate that falls on these step portions 14 cannot be smoothly drained to the drainage port 12 side due to the air flow on the air inlet 8 side in the opposite direction to the drainage direction.

Furthermore, as the air flow rate level of a blower 16 increases and the reverse air flow rate on the air inlet 8 side increases, the condensate drainage resistance on the step portion 14 side increases, which makes it difficult to smoothly drain the condensate.

Therefore, there is a problem that the condensate that falls on the bottom surface 1b of the air conditioner case 1 is not drained to the drainage port 12 side and remains stagnant.

This leads to a problem that various bacteria and molds grow on the bottom surface 1b of the air conditioner case 1 where the condensate stagnates, causing a bad smell.

### DETAILED DESCRIPTION OF THE INVENTION

The present invention has been made to solve the above-mentioned problems of the prior art, and it is an object of the present invention to provide a vehicle air conditioner which is configured to improve the structure of the bottom surface of an air conditioner case, so that the resistance to drainage of condensate due to reverse air flow from the bottom surface of the air conditioner case to a drainage port can be minimized.

Another object of the present invention is to provide a vehicle air conditioner which is configured to minimize the resistance to drainage of condensate due to reverse air flow from the bottom surface of the air conditioner case to a drainage port, so that the condensate on the cooling heat exchanger side falling to the bottom surface of the air conditioner case can be smoothly drained to a drainage port regardless of the reverse air flow.

A further object of the present invention is to provide a vehicle air conditioner which is configured to smoothly drain the condensate on the cooling heat exchanger side falling to the bottom surface of the air conditioner case to a drainage port, so that the stagnation of the condensate on the bottom surface of the air conditioner case due to a reverse air flow can be prevented.

A still further object of the present invention is to provide a vehicle air conditioner which is configured to prevent the stagnation of the condensate on the bottom surface of the air conditioner case due to a reverse air flow, so that the growth of various bacteria and mold due to stagnant condensation on the bottom surface of the air conditioner case and the resulting generation of unpleasant odor can be prevented.

In order to achieve these objects, the present invention provides a vehicle air conditioner, including: an air conditioner case; and a cooling heat exchanger installed on an internal flow path of the air conditioner case, wherein the air conditioner case includes a hopper-shaped bottom surface configured to receive condensate falling from the cooling heat exchanger and collect the condensate in a portion thereof, a drainage port configured to discharge the condensate collected on the bottom surface of the air conditioner case to the outside, a condensate drainage path configured to guide the condensate falling from the cooling heat exchanger onto the bottom surface of the air conditioner case to the drainage port, and a drainage resistance reduction part configured to reduce a condensate drainage resistance in a region from the condensate drainage path to the drainage port due to an air flow on the internal flow path of the air conditioner case.

The internal flow path of the air conditioner case may be formed to extend upward from a gravity direction lowest air inlet so that air introduced through the air inlet can flow along an air flow path extending upward in a gravity direction, the cooling heat exchanger may be installed in a horizontally lying posture so as to be inclined at a predetermined toward one direction on the air flow path of the internal flow path, and may be configured to cool the air flowing upward from the air inlet in the gravity direction along the internal flow path, and the drainage resistance reduction part may be configured to restrict air flow on the air inlet side acting on a condensate flow from the condensate drainage path to the drainage port, and reduce condensate drainage resistance from the condensate drainage path to the drainage port due to the air flow on the air inlet side.

A number of step portions protruding at different heights in the air flow path extending from the air inlet on one side to the cooling heat exchanger on the upper side may be formed on the bottom surface of the air conditioner case, and the condensate drainage path may be formed between the inner wall surface of the air conditioner case and the step portions and between the step portions.

The condensate drainage path may include a first drainage path portion configured to receive condensate of the cooling heat exchanger falling from a gravity direction lowermost portion of the cooling heat exchanger, a second drainage path portion configured to drain the condensate falling onto the first drainage path portion toward one portion of the bottom surface of the air conditioner case on the gravity direction lower side, and a third drainage path portion configured to collect the condensate drained to one portion of the bottom surface of the air conditioner case along the second drainage path portion in the gravity direction lowest drainage port.

The drainage resistance reduction part may include one or more drainage path side air flow baffles installed on the condensate drainage path to reduce a condensate drainage resistance on the condensate drainage path side due to an air flow on the internal flow path side, and one or more drainage port side air flow baffles installed around the drainage port to reduce a condensate drainage resistance on the drainage port side due to the air flow on the internal flow path side.

According to the vehicle air conditioner of the present invention, the condensate drainage path is formed on the bottom surface of the air conditioner case, and then the air flow baffles are installed to block the reverse air flow on the air inlet side toward the condensate drainage path.

Accordingly, the condensate of the cooling heat exchanger falling to the bottom surface of the air conditioner case can be smoothly drained to the drainage port, and the reverse air flow on the air inlet side generated during the condensate drainage process and the resulting condensate drainage resistance can be minimized.

In addition, since the reverse air flow on the air inlet side generated during the condensate drainage process and the resulting condensate drainage resistance can be minimized, the condensate of the cooling heat exchanger that falls to the bottom surface of the air conditioner case can be smoothly drained regardless of the reverse air flow on the air inlet side.

In addition, since the condensate of the cooling heat exchanger that falls to the bottom surface of the air conditioner case can be smoothly drained, it is possible to prevent the stagnation of condensate on the bottom surface of the air conditioner case due to the reverse air flow on the air inlet side.

In addition, since the stagnation of condensate on the bottom surface of the air conditioner case due to the reverse air flow can be prevented, it is possible to prevent the growth of various bacteria and mold due to the stagnation of condensate on the bottom surface of the air conditioner case and the resulting generation of an unpleasant odor.

### BRIEF DESCRIPTION OF THE DRAWINGS

FIG. 1 is a cross-sectional view showing a conventional vehicle air conditioner.

FIG. 2 is a cross-sectional view of the conventional vehicle air conditioner taken along line II-II in FIG. 1.

FIG. 3 is a perspective view showing a condensate drainage path on the bottom surface of an air conditioner case, in which a main feature of a vehicle air conditioner according to the present invention is shown in detail.

FIG. 4 is a side view seen from the “A” direction in FIG. 3, showing a condensate drainage path on the bottom surface of an air conditioner case, which is a main feature of the present invention.

FIG. 5 is a plan view seen from the “B” direction in FIG. 3, showing the condensate drainage path on the bottom surface of the air conditioner case, which is a main feature of the present invention,

FIG. 6 is an operation diagram showing a state in which condensate is drained through the condensate drainage path on the bottom surface of the air conditioner case, which is a main feature of the present invention.

### BEST MODE TO IMPLEMENT THE INVENTION

Hereinafter, preferred embodiments of a vehicle air conditioner according to the present invention will be described in detail with reference to the accompanying drawings. The same components as those of the previously described prior art are designated by the same reference numerals.

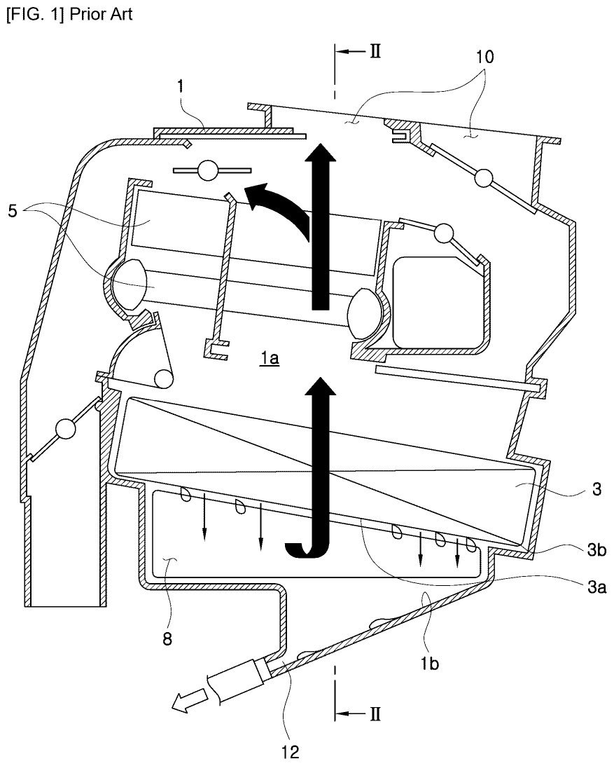

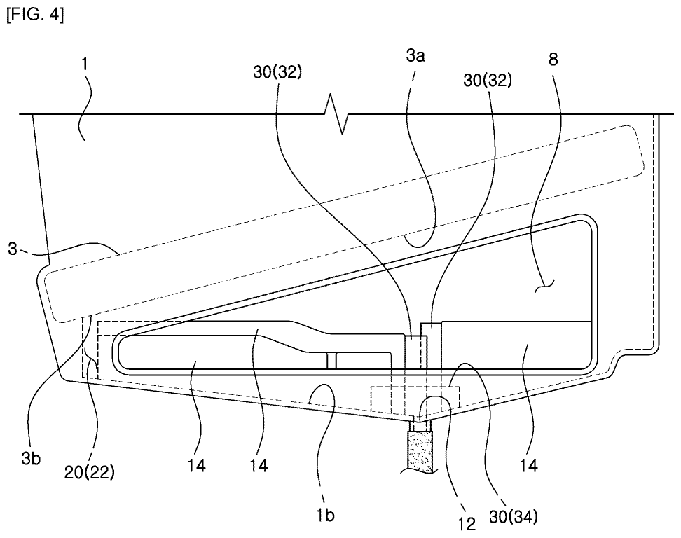

First, prior to describing the features of the vehicle air conditioner according to the present invention, the general aspect of a slim vehicle air conditioner will be briefly described with reference to FIGS. 1 to 4.

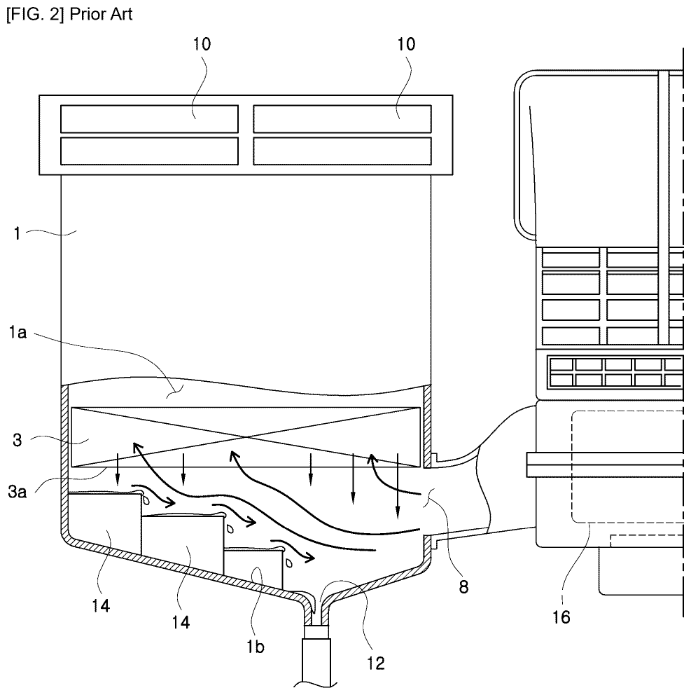

As shown in FIGS. 1 and 2, in a slim vehicle air conditioner, an internal flow path 1a of an air conditioner case 1 is formed to face upward from below in the direction of gravity, and cooling and heating heat exchangers 3 and 5 are arranged horizontally sequentially from below along the internal flow path 1a.

In particular, the cooling and heating heat exchangers 3 and 5 are sequentially arranged in a substantially horizontally lying posture from the gravity direction lower side to the gravity direction upper side along the internal flow path 1a.

The cooling and heating heat exchangers 3 and 5 arranged in this manner cool and heat the air that is introduced into a gravity direction lowest air inlet 7 in the internal flow path 1a and then flows toward gravity direction uppermost air discharge vents 10.

Meanwhile, the slim vehicle air conditioner has a condensate drainage structure for discharging condensate on the surface of the cooling heat exchanger 3.

The condensate drainage structure includes a hopper-type bottom surface 1b of the air conditioner case 1 below the cooling heat exchanger 3, and a drainage port 12 formed at the gravity direction lowest portion of the hopper-type bottom surface 1b of the air conditioner case 1.

In this condensate drainage structure, the condensate falling from the surface of the cooling heat exchanger 3 is received by the hopper-type bottom surface 1b of the air conditioner case 1, is collected near the drainage port 12 formed at the gravity direction lowest portion, and is finally discharged through the drainage port 12.

In this regard, the hopper-type bottom surface 1b of the air conditioner case 1 is arranged on the air flow path between the air inlet 8 formed at one side of the air conditioner case 1 and the cooling heat exchanger 3 on the upper side, as illustrated in FIG. 2.

In particular, the bottom surface 1b of the air conditioner case 1 is arranged on the curved air flow path between the air inlet 8 on one side and the cooling heat exchanger 3 on the upper side, which form an angle of about 90° with respect to each other based on the air flow path.

The bottom surface 1b of the air conditioner case 1 serves to guide the air introduced at a certain flow rate from the air inlet 8 on one side to the cooling heat exchanger 3 on the upper side.

Meanwhile, a plurality of step portions 14 are formed on the bottom surface 1b of the air conditioner case 1, and these step portions 14 are arranged on the curved air flow path between the air inlet 8 and the cooling heat exchanger 3.

In particular, the step portions 14 have different heights depending on the distance from the front inlet 3a of the cooling heat exchanger 3 to the air inlet 8 based on the air flow path.

For example, the farther the distance is from the front inlet 3a of the cooling heat exchanger 3 to the air inlet 8, the higher the step portions 14 becomes toward the front inlet 3a of the cooling heat exchanger 3.

The step portions 14 guide the air introduced from the air inlet 8 into the cooling heat exchanger 3 so that the air can be uniformly distributed toward the front inlet 3a side of the cooling heat exchanger 3 while sequentially colliding with the step portions 14.

Therefore, the air introduced into the front inlet 3a of the cooling heat exchanger 3 can have an overall uniform air flow rate distribution.

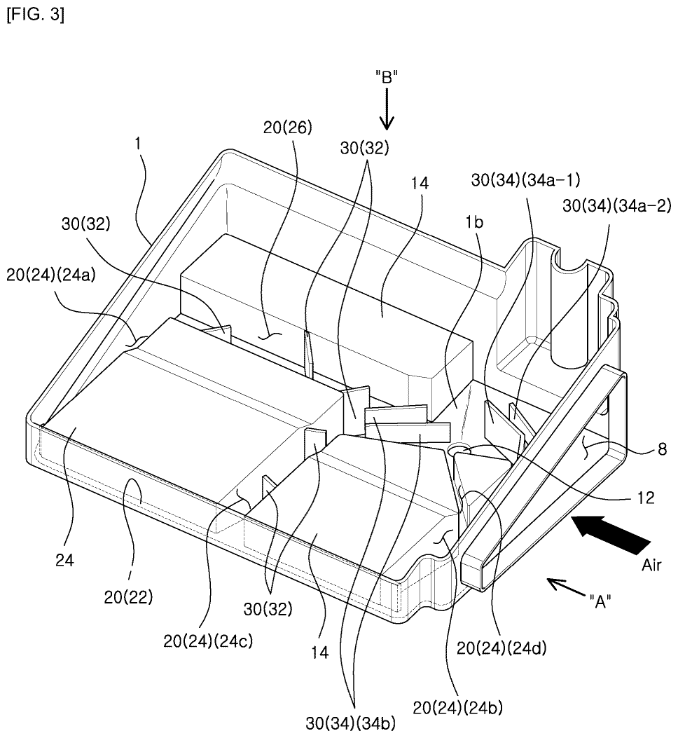

Next, the features of the vehicle air conditioner according to the present invention will be described in detail with reference to FIGS. 3 to 6.

Referring first to FIGS. 3 to 5, the vehicle air conditioner of the present invention has a condensate drainage path 20 formed on the bottom surface 1b of the air conditioner case 1.

The condensate drainage path 20 includes a first drainage path portion 22 configured to receive condensate of the cooling heat exchanger 3 that falls to a gravity direction uppermost portion of the bottom surface 1b of the air conditioner case, a second drainage path portion 24 configured to drain condensate that falls toward the first drainage path portion 22 to one portion of the bottom surface 1b of the air conditioner case 1 on the gravity direction lower side, and a third drainage path portion 26 configured to collect condensate drained to one portion of the bottom surface 1b of the air conditioner case 1 along the second drainage path portion 24 in a drainage port 12 on the gravity direction lowest side.

The first drainage path portion 22 is formed along the gravity direction uppermost corner of the bottom surface 1b of the air conditioner case 1.

In particular, the gravity direction uppermost corner of the bottom surface 1b of the air conditioner case 1 corresponds to the gravity direction lowermost portion 3b of the obliquely-installed cooling heat exchanger 3.

The uppermost corner of the bottom surface 1b of the air conditioner case 1 and the first drainage path portion 22 formed thereon receive the condensate falling from the gravity direction lowermost portion of the cooling heat exchanger using the uppermost corner of the bottom surface 1b of the air conditioner case 1.

In this regard, it is preferable that the first drainage path portion 22 be configured to have a smaller flow path cross-sectional area (A) than the second drainage path portion 24 and the third drainage path portion 26.

The second drainage path portion 24 includes side drainage path portions 24a and 24b formed to extend from both ends of the first drainage path portion 22 toward the gravity direction lower side along both edges of the bottom surface 1b of the air conditioner case 1, and a center drainage path 24c formed to extend from an intermediate portion of the first drainage path portion 22 toward the gravity direction lower side.

The second drainage path 24 drains condensate falling onto the first drainage path portion 22 toward one portion of the bottom surface 1b of the air conditioner case 1 on the gravity direction lower side through both edges and the intermediate portion of the bottom surface 1b of the air conditioner case 1.

In particular, the side drainage path portions 24a and 24b on both sides guide the condensate on the first drainage path portion 22 side along both edges of the bottom surface 1b of the air conditioner case 1 and drain the condensate to one portion of the bottom surface 1b of the air conditioner case 1 on the gravity direction lower side.

The center drainage path portion 24c guides the condensate on the first drainage path portion 22 side along the intermediate portion of the bottom surface 1b of the air conditioner case 1 and drains the condensate to one portion of the bottom surface 1b of the air conditioner case 1 on the gravity direction lower side.

In this regard, the side drainage path portions 24a and 24b on both sides of the second drainage path portion 24 are preferably formed between the side walls of the air conditioner case 1 among the edges of the bottom surface 1b of the air conditioner case 1 and the step portions 14 formed on the bottom surface 1b of the air conditioner case 1.

The reason for adopting this configuration is to ensure that, by forming the side drainage path portions 24a and 24b between the side walls of the air conditioner case 1 and the step portions 14, the air directly blown from the air inlet 8 to the side drainage path portions 24a and 24b can be blocked by the step portions 14.

Therefore, by minimizing the air flow on the side of the air inlet 8 acting on the side drainage path portions 24a and 24b, it is possible to minimize the condensate drainage resistance in the side drainage path portions 24a and 24b.

The center drainage path portion 24c of the second drainage path portion 24 is preferably formed between the step portions 14 formed on the bottom surface 1b of the air conditioner case 1 in the intermediate portion of the first drainage path portion 22.

The reason for adopting this configuration is to ensure that, by forming the center drainage path portion 24c between the step portions 14, the air directly blown from the air inlet 8 to the center drainage path 24c can be blocked by the step portions 14.

Therefore, by minimizing the air flow on the air inlet 8 side acting on the center drainage path portion 24c, it is possible to minimize the condensate drainage resistance in the center drainage path portion 24c.

It is preferable that the side drainage path portions 24a and 24b and the center drainage path portion 24c of the second drainage path portion 24 are configured to increase in the flow path cross-sectional area as they get closer to the drainage port 12.

For example, among the side drainage path portions 24a and 24b and the center drainage path portion 24c, the flow path cross-sectional area (B) of the side drainage path portion 24a that is farthest from the drainage port 12 is the smallest.

It is preferable that the flow path cross-sectional areas (C and D) are set to increase in order from the farthest side to the nearest side with respect to the drainage port 12, i.e., in the order of the center drainage path portion 24c and the other side drainage path portion 24b.

Meanwhile, the third drainage portion 26 is configured to face the drainage port 12 in the lowest portion of the bottom surface 1b of the air conditioner case 1 while being connected to the ends of the side drainage path portions 24a and 24b and the center drainage path portion 24c of the second drainage path portion 24.

The third drainage path portion 26 causes the condensate drained along the side drainage path portions 24a and 24b and the center drainage path portion 24c of the second drainage path portion 24 to be collected in the drainage port 12 on the gravity direction lowest side.

Therefore, the collected condensate can be discharged to the outside while being finally drained to the drainage port 12.

In this regard, it is preferable that the third drainage path portion 26 has a flow path cross-sectional area (E) greater than the flow path cross-sectional areas (B, C and D) of the second drainage path portion 24.

In particular, since the third drainage path portion 26 is directly connected to the drainage port 12, the third drainage path portion 26 is closer to the drainage port 12 than the second drainage path portion 24.

Therefore, based on the distance of the drainage port 12, it is preferable that the third drainage path portion 26 has a flow path cross-sectional area (E) greater than the flow path cross-sectional areas (B, C and D) of the second drainage path portion 24.

Meanwhile, the third drainage path portion 26 may be connected to only one of the side drainage path portions 24a and 24b and the center drainage path section 24c of the second drainage path portion 24, and only the condensate of the connected drainage path portion may be collected toward the drainage port 12.

At this time, the remaining drainage path portions are directly connected to the drainage port 12 to directly collect the corresponding condensate toward the drainage port 12.

For example, the third drainage path portion 26 is connected to one side drainage path portion 24a relatively far from the drainage port 12 among the two side drainage path portions 24a and 24b and the center drainage path section 24c of the second drainage path portion 24, so that only the condensate of the one side drainage path portion 24a can be collected toward the drainage port 12.

At this time, the other side drainage path portion 24b and the center drainage path portion 24c of the second drainage path portion 24, which are relatively close to the drainage port 12, are directly connected to the drainage port 12 to directly collect the corresponding condensate toward the drainage port 12.

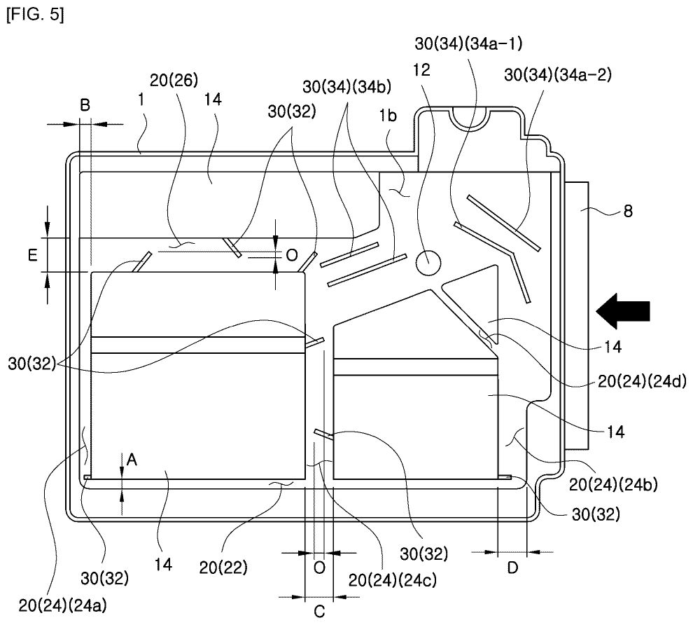

Meanwhile, referring to FIGS. 3 and 5, the drainage port 12 is formed in a portion of the bottom surface 1b of the air conditioner case 1, which is close to the air inlet 8 formed on one side of the air conditioner case 1.

In particular, the drainage port 12 is formed on the condensate flow path of the third drainage path portion 26 on the bottom surface 1b of the air conditioner case 1, which is close to the air inlet 8.

The first drainage path portion 22 is formed along the edge of the gravity direction uppermost portion of the bottom surface 1b of the air conditioner case 1, and is formed in a direction parallel to the flow direction of the blown air on the air inlet 8 side.

The side drainage path portions 24a and 24b and the center drainage path portion 24c of the second drainage path portion 24 extend downward in the gravity direction from the first drainage path portion 22, but are formed in a direction perpendicular to the direction of the air flow introduced to the air inlet 8 side.

The third drainage path portion 26 extends from the end of the second drainage path portion 24 toward the drainage port 12 on the gravity direction lower side, but is formed in a direction parallel to the direction of the air flow introduced to the air inlet 8 side.

Therefore, the third drainage path portion 26 collects the condensate drained along the side drainage path portions 24a and 24b and the center drainage path portion 24c of the second drainage path portion 24 toward the drainage port 12 on the air inlet 8 side.

Meanwhile, at least one of the center drainage path portion 24c and the side drainage path portions 24a and 24b of the second drainage path portion 24 further has a direct drainage path portion 24d that can directly drain the condensate of the corresponding flow path toward the drainage port 12 through the shortest path without passing through the third drainage path portion 26.

It is preferable that the direct drainage path portion 24d is formed in the side drainage path portions 24a and 24b which are closer to the air inlet 8 than the center drainage path portion 24c.

The direct drainage path portion 24d directly drains the condensate drained along the side drainage path portion 24b on one edge of the bottom surface 1b of the air conditioner case 1 toward the drainage port 12 through the shortest path.

It is preferable that the direct drainage path portion 24d be formed by partially cutting the step portions 14 formed between the side drainage path 24b and the drainage port 12.

Referring again to FIGS. 3 to 5, the vehicle air conditioner of the present invention further includes a drainage resistance reduction part 30 configured to reduce a condensate drainage resistance in a flow path from the condensate drainage path 20 to the drainage port 12, which may be caused by the air flow of the blown air on the air inlet 8 side.

The drainage resistance reduction part 30 includes one or more drainage path side air flow baffles 32 installed on the condensate drainage path 20 and one or more drainage port side air flow baffles 34 installed on the periphery of the drainage port 12.

The drainage path side air flow baffles 32 are formed in a flow path portion where the degree of exposure of the condensate to the air flow of the blown air on the air inlet 8 side is greater than other portions, among the first to third drainage path portions 22, 24 and 26 of the condensate drainage path 20.

For example, the drainage path side air flow baffles 32 are formed in a flow path portion where the drainage direction of the condensate is parallel to the direction of the air flow blown from the air inlet 8 side and thus the degree of exposure of the condensate to the air flow of the blown air on the air inlet 8 side is greater than other portions, and a flow path portion where the cross-sectional area is greater than other portions and thus the condensate is heavily affected by the air flow of the air blown from the air inlet 8 side, among the first to third drainage path portions 22, 24 and 26.

The flow path portion where the condensate drainage direction is parallel to the direction of the air flow of the air blown from the air inlet 8 side is the third drainage path portion 26 among the first to third drainage path portions 22, 24 and 26, and the drainage path side air flow baffles 32 are installed in the third drainage path portion 26.

In particular, since the third drainage path portion 26 is formed in a direction parallel to the direction of the air flow of the air on the air inlet 8 side, the direction of the condensate drainage directly corresponds to the direction of the air flow on the air inlet 8 side. Thus, the drainage path side air flow baffles 32 are installed in the third drainage path portion 26.

The drainage path side air flow baffles 32 installed in the third drainage path portion 26 are alternately installed at predetermined intervals on both side walls of the third drainage path portion 26.

In particular, the respective drainage path side air flow baffles 32 are alternately installed on both side walls of the third drainage path portion 26, and are installed inward from the side surfaces of the third drainage path portion 26.

The drainage path side air flow baffles 32 installed on the third drainage path 26 side restrict the reverse air flow from the air inlet 8 side toward the third drainage path 26 portion.

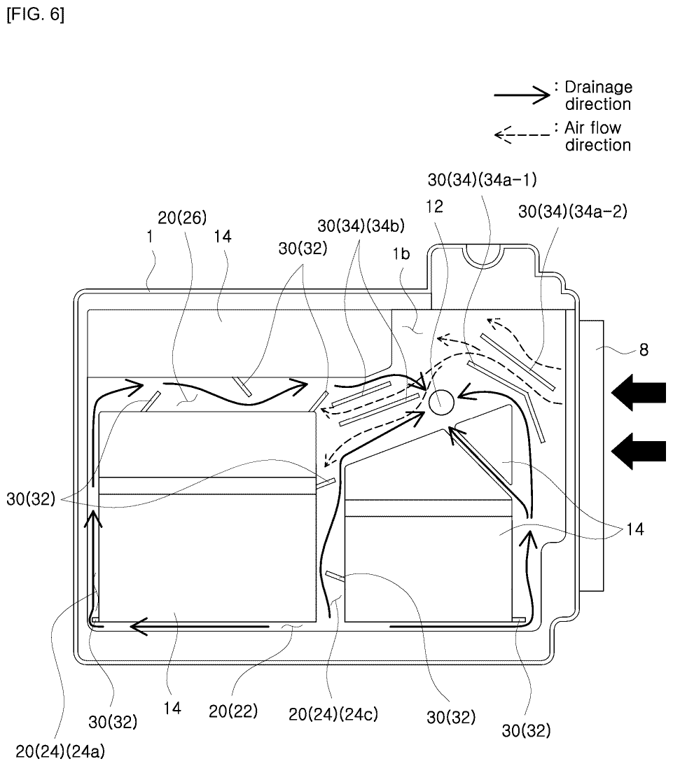

In particular, as illustrated in FIG. 6, the drainage path side air flow baffles 32 serve to restrict the reverse air flow flowing into the interior of the third drainage path 26 from the air inlet 8 side.

Therefore, the condensate drainage resistance on the third drainage path 26 side due to the reverse air flow on the air inlet 8 side is minimized.

As a result, the condensate on the third drainage path portion 26 side can be smoothly drained toward the drainage port 12 without being affected by the reverse air flow on the air inlet 8 side.

In this regard, the drainage path side air flow baffles 32 are installed inward from both side walls of the third drainage path portion 26, and are installed at a height from the bottom surface of the third drainage path part 26 to the upper end of the side walls.

In addition, the drainage path side air flow baffles 32 are installed inward from both side walls of the third drainage path portion 26, and are installed so that their ends are tilted at a certain angle toward the drainage direction of the condensate.

Therefore, the drainage path side air flow baffles 32 are configured to facilitate the flow of the condensate drained along the third drainage path portion 26, and to restrict the reverse air flow from the air inlet 8 side to the third drainage path portion 26.

In addition, the drainage path side air flow baffles 32 are alternately installed inward from both side walls of the third drainage path portion 26, and the ends of the drainage path side air flow baffles 32 alternately installed on both side walls are preferably configured to overlap each other with respect to the air flow direction on the air inlet 8 side.

This is to block the reverse air flow from the air inlet 8 side of the air flowing back along the third drainage path portion 26 as much as possible.

Referring again to FIGS. 3 to 5, among the first to third drainage path portions 22, 24 and 26, the center drainage path portion 24c of the second drainage path portion 24 has a relatively large cross-sectional area and receives a relatively large air flow from the air inlet 8. The drainage path side air flow baffles 32 are installed in the center drainage path portion 24c of the second drainage path portion 24.

The drainage path side air flow baffles 32 installed in the center drainage path portion 24c are alternately installed at regular intervals on both side walls of the center drainage path portion 24c.

In particular, the drainage path side air flow baffles 32 are alternately installed on both side walls of the center drainage path portion 24c, and are installed inward from the side surfaces of the center drainage path portion 24c.

The drainage path side air flow baffles 32 of the center drainage path portion 24c restrict the reverse air flow from the air inlet 8 side to the center drainage path portion 24c.

In particular, as illustrated in FIG. 6, the drainage path side air flow baffles 32 serve to limit the reverse air flow into the center drainage path portion 24c from the air inlet 8 side.

Therefore, the condensate drainage resistance on the center drainage path portion 24c side due to the reverse air flow from the air inlet 8 side is minimized.

As a result, the condensate of the center drainage path portion 24c can be smoothly drained to the drainage port 12 without being affected by the reverse air flow from the air inlet 8 side.

In this regard, the drainage path side air flow baffles 32 are installed inward from both side walls of the center drainage path portion 24c, and are installed at a height from the bottom surface of the center drainage path portion 24c to the upper ends of the side walls.

In addition, the drainage path side air flow baffles 32 are installed inward from both side walls of the center drainage path portion 24c, and are installed so that the ends thereof are tilted at a certain angle toward the drainage direction of the condensate.

Therefore, the drainage path side air flow baffles 32 are configured to facilitate the flow of the condensate drained along the center drainage path portion 24c, and to restrict the reverse air flow from the air inlet 8 side to the center drainage path portion 24c side.

In addition, the drainage path side air flow baffles 32 are alternately installed inward from both side walls of the center drainage path portion 24c, and the ends of the drainage path side air flow baffles 32 alternately installed on both side walls are configured to overlap each other based on the flow direction of the air on the air inlet 8 side.

Meanwhile, the drainage path side air flow baffles 32 may be additionally installed between the first drainage path portion 22 of the condensate drainage path 20 and the side drainage path portions 24a and 24b, as shown in FIGS. 5 and 6.

That is, the drainage path side air flow baffles 32 protrude from both ends of the first drainage path portion 22 toward the inside of the side drainage path portions 24a and 24b by a certain length.

The drainage path side air flow baffles 32 restrict the air flow on the air inlet 8 from the side drainage path portions 24a and 24b on both sides to the side of the first drainage path portion 22.

Therefore, it is possible to reduce the condensate drainage resistance between the first drainage path portion 22 and the side drainage paths 24a and 24b, which is caused by the reverse air flow on the air inlet 8.

Referring again to FIGS. 3 to 5, the drainage port side air flow baffles 34 of the drainage resistance reduction part 30 is installed on a portion of the bottom surface 1b of the air conditioner case 1 around the drainage port 12.

In particular, the drainage port side air flow baffles 34 are installed on a portion of the bottom surface 1b of the air conditioner case 1 between the air inlet 8 and the drainage port 12 and on a portion of the bottom surface 1b of the air conditioner case 1 between the third drainage path portion 26 and the drainage port 12.

Among the drainage port side air flow baffles 34, the drainage port side air flow baffle 34a installed between the air inlet 8 and the drainage port 12 blocks the air flow directly blown from the air inlet 8 side to the drainage port 12 side.

Therefore, the drainage resistance around the drainage port 12 due to the air flow on the side of the air inlet 8 is minimized.

In particular, the condensate drained from the condensate drainage path 20 is collected around the drainage port 12, and the collected condensate should flow toward the drainage port 12. However, the flow of condensate toward the drainage port 12 can be blocked by the air flow on the side of the air inlet 8.

Therefore, by blocking the direct air flow from the side of the air inlet 8 to the side of the drainage port 12, the condensate collected around the drainage port 12 can be smoothly drained toward the side of the drainage port 12.

The drainage port side air flow baffles 34a are installed between the air inlet 8 and the drainage port 12, and are installed in a pair at a regular interval.

In particular, the pair of drainage port side air flow baffles 34a are installed in parallel to overlapped with each other at a regular interval toward the radial outer side based on the drainage port 12.

At this time, the pair of drainage port side air flow baffles 34a are installed between the air inlet 8 and the drainage port 12, and are formed in a structure that does not obstruct the flow of condensate drained from the condensate drainage path 20 to the drainage port 12 side.

For example, the pair of drainage port side air flow baffles 34a are installed between the air inlet 8 and the drainage port 12, and are installed along the flow direction of the condensate drained from the condensate drainage path 20 to the drainage port 12 side.

The pair of drainage port side air flow baffles 34a installed in this way also have a function of guiding the condensate drained from the condensate drainage path 20 to the drainage port 12 side.

In addition, the pair of drainage port side air flow baffles 34a are installed between the air inlet 8 and the drainage port 12, and are configured to have a lower height than the drainage path side air flow baffles 32 installed on the condensate drainage path 20 side.

The reason for adopting this configuration is that if the pair of drainage port side air flow baffles 34a have a larger height than the drainage path side air flow baffles 32, they may rather obstruct the air flow on the air inlet 8 side.

In addition, among the pair of drainage port side air flow baffles 34a, the inner baffle 34a-1, which is closer to the drainage port 12, is configured to have a larger height than the outer baffle 34a-2.

This is to minimize the influence of the air flow in the air inlet 8 on the condensate drainage on the drainage port 12 side while not obstructing the air flow on the air inlet 8 side.

Meanwhile, among the drainage port side air flow baffles 34, the drainage port side air flow baffles 34b installed between the third drainage path portion 26 and the drainage port 12 block the air flow on the air inlet 8 side acting between the third drainage path portion 26 and the drainage port 12.

In particular, the third drainage path portion 26 corresponds to the air inlet 8 with the drainage port 12 interposed therebetween, and the condensate of the third drainage path portion 26 corresponding to the air inlet 8 is discharged to the drainage port 12 side while counteracting the air flow on the air inlet 8 side.

At this time, the drainage port side air flow baffles 34b block the air flow on the air inlet 8 side that acts on the condensate flow from the third drainage path portion 26 side to the drainage port 12 side.

Therefore, the drainage resistance from the third drainage path portion 26 to the drainage port 12 side due to the air flow on the air inlet 8 side is minimized.

In particular, in the area between the third drainage path portion 26 and the drainage port 12, the condensate drained along the third drainage path portion 26 is collected around the drainage port 12, and the collected condensate should flow toward the drainage port 12. However, the flow of the condensate toward the drainage port 12 may be blocked by the air flow from the air inlet 8 side.

Therefore, the drainage port side air flow baffles 34b block the air blown from the air inlet 8 side and acting between the third drainage path portion 26 and the drainage port 12, thereby allowing the condensate collected around the drainage port 12 to be smoothly drained toward the drainage port 12 side.

The drainage port side air flow baffles 34b are installed between the third drainage path portion 26 and the drainage port 12, and are installed in a pair at a regular interval.

In particular, the pair of drainage port side air flow baffles 34b are installed in parallel to overlap with each other at a regular interval toward the radial outer side based on the drainage port 12.

At this time, the pair of drainage port side air flow baffles 34b are installed between the third drainage path portion 26 and the drainage port 12, and are formed in a structure that does not obstruct the flow of the condensate drained from the third drainage path portion 26 to the drainage port 12.

For example, the pair of drainage port side air flow baffles 34b are installed between the third drainage path portion 26 and the drainage port 12, and are installed along the flow direction of the condensate drained from the third drainage path portion 26 to the drainage port 12.

The pair of drainage port side air flow baffles 34b installed in this way also has a function of guiding the condensate drained from the third drainage path part 26 to the drainage port 12.

In addition, the pair of drainage port side air flow baffles 34b are installed between the third drainage path portion 26 and the drainage port 12, and are configured to have a smaller height than the drainage path side air flow baffles 32 installed in the third drainage path portion 26.

The reason for adopting this configuration is that if the drainage port side air flow baffles 34b have a larger height than the drainage path side air flow baffles 32, they may actually impede the air flow on the air inlet 8 side.

According to the vehicle air conditioner of the present invention having the above-described configuration, the condensate drainage path 20 is formed on the bottom surface 1b of the air conditioner case 1, and then the air flow baffles 32 and 34 are installed to block the reverse air flow on the air inlet 8 side toward the condensate drainage path 20.

Accordingly, the condensate of the cooling heat exchanger 3 falling to the bottom surface 1b of the air conditioner case 1 can be smoothly drained to the drainage port 12, and the reverse air flow on the air inlet 8 side generated during the condensate drainage process and the resulting condensate drainage resistance can be minimized.

In addition, since the reverse air flow on the air inlet 8 side generated during the condensate drainage process and the resulting condensate drainage resistance can be minimized, the condensate of the cooling heat exchanger 3 that falls to the bottom surface 1b of the air conditioner case 1 can be smoothly drained regardless of the reverse air flow on the air inlet 8 side.

In addition, since the condensate of the cooling heat exchanger 3 that falls to the bottom surface 1b of the air conditioner case 1 can be smoothly drained, it is possible to prevent the stagnation of condensate on the bottom surface 1b of the air conditioner case 1 due to the reverse air flow on the air inlet 8 side.

In addition, since the stagnation of condensate on the bottom surface 1b of the air conditioner case 1 due to the reverse air flow can be prevented, it is possible to prevent the growth of various bacteria and mold due to the stagnation of condensate on the bottom surface 1b of the air conditioner case 1 and the resulting generation of an unpleasant odor.

While the preferred embodiments of the present invention have been described above by way of example, the scope of the present invention is not limited to such specific embodiments, and may be appropriately changed within the scope recited in the claims.

What is claimed is:

1. A vehicle air conditioner, comprising:
an air conditioner case; and
a cooling heat exchanger installed on an internal flow path of the air conditioner case,
wherein the air conditioner case includes a hopper-shaped bottom surface configured to receive condensate falling from the cooling heat exchanger and collect the condensate in a portion thereof, a drainage port configured to discharge the condensate collected on the bottom surface of the air conditioner case to the outside, a condensate drainage path configured to guide the condensate falling from the cooling heat exchanger onto the bottom surface of the air conditioner case to the drainage port, and a drainage resistance reduction part configured to reduce a condensate drainage resistance in a region from the condensate drainage path to the drainage port due to an air flow on the internal flow path of the air conditioner case.

2. The vehicle air conditioner of claim 1, wherein the internal flow path of the air conditioner case is formed to extend upward from a gravity direction lowest air inlet so that air introduced through the air inlet can flow along an air flow path extending upward in a gravity direction,
the cooling heat exchanger is installed in a horizontally lying posture so as to be inclined at a predetermined toward one direction on the air flow path of the internal flow path, and is configured to cool the air flowing upward from the air inlet in the gravity direction along the internal flow path, and
the drainage resistance reduction part is configured to restrict air flow on the air inlet side acting on a condensate flow from the condensate drainage path to the drainage port, and reduce condensate drainage resistance from the condensate drainage path to the drainage port due to the air flow on the air inlet side.

3. The vehicle air conditioner of claim 2, wherein a number of step portions protruding at different heights in the air flow path extending from the air inlet on one side to the cooling heat exchanger on the upper side are formed on the bottom surface of the air conditioner case, and
the condensate drainage path is formed between the inner wall surface of the air conditioner case and the step portions and between the step portions.

4. The vehicle air conditioner of claim 3, wherein the condensate drainage path includes a first drainage path portion configured to receive condensate of the cooling heat exchanger falling from a gravity direction lowermost portion of the cooling heat exchanger, a second drainage path portion configured to drain the condensate falling onto the first drainage path portion toward one portion of the bottom surface of the air conditioner case on the gravity direction lower side, and a third drainage path portion configured to collect the condensate drained to one portion of the bottom surface of the air conditioner case along the second drainage path portion in the gravity direction lowest drainage port.

5. The vehicle air conditioner of claim 4, wherein the first drainage path portion is formed along an edge of a gravity direction uppermost portion of the bottom surface of the air conditioner case corresponding to a gravity direction lowest portion of the cooling heat exchanger.

6. The vehicle air conditioner of claim 5, wherein the second drainage path portion includes side drainage path portions formed from both ends of the first drainage path portion toward one portion on the gravity direction lower side along both edges of the bottom surface of the air conditioner case, and a center drainage path portion formed from an intermediate portion of the first drainage path portion toward one portion on the gravity direction lower side along the bottom surface of the air conditioner case.

7. The vehicle air conditioner of claim 6, wherein the third drainage path portion is formed to extend toward the gravity direction lowest drainage port while being connected to the ends of the side drainage path portions and the center drainage path portion of the second drainage path portion, and
the condensate drained to one portion of the bottom surface of the air conditioner case along the side drainage path portions and the center drainage path portion is collected toward the drainage port.

8. The vehicle air conditioner of claim 6, wherein the first drainage path portion is formed along an edge of a gravity direction uppermost portion of the bottom surface of the air conditioner case in a direction parallel to the flow direction of the air on the air inlet side,
the side drainage path portions and the center drainage path portion of the second drainage path portion are formed in a direction perpendicular to the flow direction of the air on the air inlet side from the first drainage path portion, and
the third drainage path portion is formed to extend toward the drainage port in a direction parallel to the flow direction of the air on the air inlet side from the ends of the side drainage path portions and the center drainage path portion of the second drainage path portion.

9. The vehicle air conditioner of claim 8, wherein the drainage port is formed on the condensate flow path of the third drainage path portion near the air inlet on the bottom surface of the air conditioner case.

10. The vehicle air conditioner of claim 4, wherein the first drainage path portion among the first to third drainage path portions has a smallest flow path cross-sectional area, and
the second and third drainage path portions have a larger flow path cross-sectional area as the second and third drainage path portions are closer to the drainage port.

11. The vehicle air conditioner of claim 1, wherein the drainage resistance reduction part includes one or more drainage path side air flow baffles installed on the condensate drainage path to reduce a condensate drainage resistance on the condensate drainage path side due to an air flow on the internal flow path side, and one or more drainage port side air flow baffles installed around the drainage port to reduce a condensate drainage resistance on the drainage port side due to the air flow on the internal flow path side.

12. The vehicle air conditioner of claim 11, wherein the drainage path side air flow baffles are formed in a flow path portion of the condensate drainage path where the degree of exposure to the air flow on the internal flow path side is greater than other portions.

13. The vehicle air conditioner of claim 12, wherein the flow path portion of the condensate drainage path where the degree of exposure to the air flow on the internal flow path side is greater than other portions includes a flow path portion of the condensate drainage path formed in a direction parallel to the air flow on the internal flow path side, and a flow path portion of the condensate drainage path that has a larger flow path cross-sectional area than other portions and receives a larger air flow on the internal flow path side than other portions.

14. The vehicle air conditioner of claim 13, wherein the flow path portion of the condensate drainage path formed in a direction parallel to the air flow on the internal flow path side is the third drainage path portion formed in a direction parallel to the air flow on the air inlet side in the internal flow path among the first to third drainage path portions of the condensate drainage path, and
the drainage path side air flow baffles are alternately installed at regular intervals on both side walls of the third drainage path portion to restrict the air flow from the air inlet to the third drainage path portion and reduce the condensate drainage resistance in the third drainage path portion due to the air flow on the air inlet side.

15. The vehicle air conditioner of claim 14, wherein the flow path portion of the condensate drainage path that has a larger flow path cross-sectional area than other portions and receives a larger air flow on the internal flow path side than other portions is the center drainage path portion of the second drainage path portion having a larger flow path cross-sectional area than the first drainage path portion among the first to third drainage path portions of the condensate drainage path, and
the drainage path side air flow baffles are alternately installed at regular intervals on both side walls of the center drainage path portion to restrict the air flow from the air inlet to the center drainage path portion and reduce the condensate drainage resistance in the center drainage path portion due to the air flow on the air inlet side.

16. The vehicle air conditioner of claim 15, wherein the drainage path side air flow baffles are installed inward from both side walls of the drainage path portion by a predetermined length, and are installed at a height from the bottom surface of the drainage path portion to the upper ends of the side walls thereof.

17. The vehicle air conditioner of claim 15, wherein the drainage path side air flow baffles are installed alternately inward from both side walls of the drainage path portion so that the ends of the drainage port side air flow baffles on both sides overlap each other based on the flow direction of the air on the air inlet side.

18. The vehicle air conditioner of claim 11, wherein the drainage path side air flow baffles protrude from both ends of the first drainage path of the condensate drainage path toward the inside of each of the side drainage path portions of the second drainage path portion by a predetermined length to restrict the air flow of the air flowing into the first drainage path portion each of the side drainage path portions.

19. The vehicle air conditioner of claim 11, wherein the drainage port side air flow baffles are installed on a portion of the bottom surface of the air conditioner case between the air inlet and the drainage port to block the flow of the air blown from the air inlet side to the drainage port side and reduce the drainage resistance around the drainage port due to the air flow on the air inlet side.

20. The vehicle air conditioner of claim 19, wherein the drainage port side air flow baffles are installed on a portion of the bottom surface of the air conditioner case between the third drainage path portion and the drainage port to block the flow of the air blown from the air inlet side and acting between the third drainage path portion and the drainage port and reduce the drainage resistance from the third drainage path portion to the drainage port due to the air flow on the air inlet side.
